(19) United States
(12) Patent Application Publication
(10) Pub. No.: US 2013/0058303 A1
(43) Pub. Date: Mar. 7, 2013

(54) METHOD AND APPARATUS FOR ALLOCATING RESOURCES IN A WIRELESS COMMUNICATION SYSTEM

(71) Applicant: Sungkwon Hong, Seoul (KR)

(72) Inventor: Sungkwon Hong, Seoul (KR)

(73) Assignee: PANTECH CO., LTD., Seoul (KR)

(21) Appl. No.: 13/696,255

(22) PCT Filed: Apr. 28, 2011
(86) PCT No.: PCT/KR2011/003179

§ 371 Date: Nov. 5, 2012

(30) Foreign Application Priority Data
May 4, 2010 (KR) 10-2010-0041810

(51) Int. Cl. H04W 72/04

(52) U.S. Cl. 370/329

(57) ABSTRACT

The present invention relates to resource allocation in a wireless communication system.

### CROSS-REFERENCE TO RELATED APPLICATIONS

This application is the National Stage Entry of International Application No. PCT/KR2011/003179, filed on Apr. 28, 2011, and claims priority from and the benefit of Korean Patent Application No. 10-2010-0041810, filed on May 4, 2010, which are hereby incorporated by reference for all purposes as if fully set forth herein.

### BACKGROUND

1. Field

The present invention relates to resource allocation in a wireless communication system.

2. Discussion of the Background

In a wireless communication system, one of the basic principles of wireless access may be shared channel transmission, that is, dynamic sharing of time-frequency resources among user equipments. To achieve the above, a base station may control allocation of uplink and downlink resources.

### SUMMARY

Therefore, the present invention has been made in view of the above-mentioned problems, and an aspect of the present invention is to provide a method and apparatus for effective resource allocation in a wireless communication system.

In accordance with an aspect of the present invention, there is provided a resource allocating apparatus, the apparatus including: a resource allocation information generating unit to replace each cluster including two or more resource block groups with a single substitute resource block group and to generate resource allocation information based on a number of entire resource block groups including the substitute resource block group, a number of clusters, and substitute resource block group information when resource allocation is performed with respect to one or more clusters having an identical cluster length in the entire resource block groups; and a resource allocation information transmitting unit to transmit the resource allocation information.

In accordance with another aspect of the present invention, there is provided a method of allocating resources, the method including: replacing each cluster including two or more resource block groups with a single substitute resource block group and generating resource allocation information based on a number of entire resource block groups including the substitute resource block group, a number of clusters, and substitute block group information when resource allocation is performed with respect to one or more clusters having an identical cluster length in the entire resource block groups; and transmitting the resource allocation information.

In accordance with another aspect of the present invention, there is provided a resource allocation receiving apparatus, the apparatus including: a resource allocation information receiving unit to receive, from a resource allocating apparatus, resource allocation information generated based on a number of entire resource block groups including a substitute resource block group, a number of clusters, and substitute resource block group information when resource allocation is performed in the entire resource block groups and each cluster including two or more resource block groups and having an identical cluster length is replaced with a single substitute resource block group; and a resource allocation information restoring unit to recognize the cluster length and the substitute resource block group information from the received resource allocation information, to restore start resource block group information of each cluster based on the cluster length and the substitute resource block group information, and to restore end resource block group information of each cluster based on the restored start resource block group information and the cluster length.

In accordance with another aspect of the present invention, there is provided a resource allocation receiving method, the method including: receiving, from a resource allocating apparatus, resource allocation information generated based on a number of entire resource block groups including a substitute resource block group, a number of clusters, and substitute resource block group information when resource allocation is performed in the entire resource block groups and each cluster including two or more resource block groups and having an identical cluster length is replaced with a single substitute resource block group; and recognizing the cluster length and the substitute resource block group information from the received resource allocation information, restoring start resource block group information of each cluster based on the cluster length and the substitute resource block group information, and restoring end resource block group information of each cluster based on the restored start resource block group information and the cluster length.

In accordance with another aspect of the present invention, there is provided a method for a base station to transmit control information, the method including: adding a Cyclic Redundancy Check (CRC) for error detection to control information including resource allocation information that is expressed as RIV(n, x, S₀, . . . , Sₖ₋₁) or RIV^{multi}(n,x,k); generating coded data by performing channel coding on the CRC-added control information; generating modulated symbols by modulating the coded data; and mapping the modulated symbols on a physical resource element and transmitting the mapped modulated symbols to a user equipment.

In accordance with another aspect of the present invention, there is provided a method for a user equipment to process control information, the method including: demapping symbols from a received physical resource element; generating data by demodulating the demapped symbols; performing channel decoding on the demodulated data and performing CRC so as to detect whether an error occurs; obtaining required control information by removing a CRC from the decoded data; and interpreting, based on the obtained control information, resource allocation information expressed as RIV(n, x, S₀, . . . , Sₖ₋₁) or RIV^{multi} (n,x,k).

### BRIEF DESCRIPTION OF THE DRAWINGS

FIG. 1 is a diagram illustrating a wireless communication system according to embodiments of the present invention;

FIG. 2 is a diagram illustrating a resource allocating apparatus and a resource allocation receiving apparatus for resource allocation in a wireless communication system;

FIG. 3 is a diagram illustrating an example of resource allocation according to an embodiment of the present invention;

FIG. 4 is a diagram illustrating a resource allocating apparatus according to an embodiment of the present invention;

FIG. 5 is a flowchart illustrating a resource allocation method according to an embodiment of the present invention;

FIG. 6 is a diagram illustrating a resource allocation receiving apparatus according to an embodiment of the present invention;

FIG. 7 is a flowchart illustrating a resource allocation receiving method according to an embodiment of the present invention;

FIG. 8 is a flowchart illustrating a configuration of a PDCCH according to another embodiment of the present invention;

FIGS. 9 and 11 are block diagrams illustrating a transmitting apparatus of a base station and a receiving apparatus of a user equipment; and

FIG. 10 is a flowchart illustrating PDCCH processing according to another embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

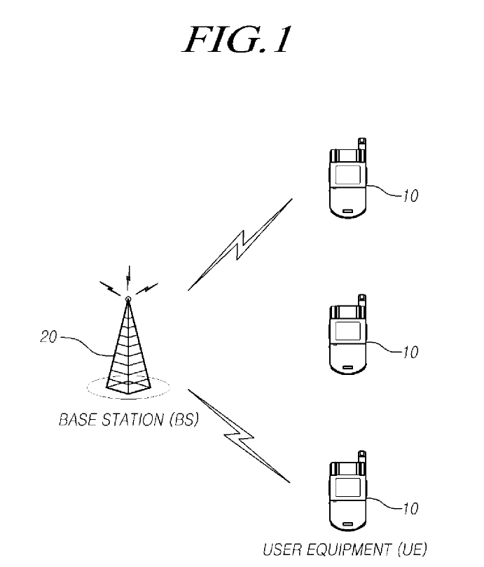

FIG. 1 is a block diagram illustrating a wireless communication system according to embodiments of the present invention.

The wireless communication system may be widely installed so as to provide various communication services, such as a voice service, packet data, and the like.

Referring to FIG. 1, the wireless communication system may include a user equipment (UE) 10 and a base station (BS) 20. The user equipment 10 and the base station 20 may use various resource allocation methods to be described below.

Throughout the specifications, the user equipment 10 may be an inclusive concept indicating a user terminal utilized in wireless communication, including a User Equipment (UE) in WCDMA, LTE, HSPA, and the like, and a mobile station (MS), a user terminal (UT), a subscriber station (SS), a wireless device, and the like in GSM.

In general, the base station 20 or a cell may refer to a station, and may also be referred to as a Node-B, an evolved Node-B (eNB), a Base Transceiver System (BTS), an access point, and the like. In the specifications, the user equipment 10 and the base station 20 are used as two inclusive transceiving subjects to embody the technology and technical concepts described in the specifications, and may not be limited to a predetermined term or word.

An embodiment of the present invention may be applicable to resource allocation in an asynchronous wireless communication scheme that is advanced through GSM, WCDMA, and HSPA, to be Long Term Evolution (LTE) and LTE-advanced, and may be applicable to resource allocation in a synchronous wireless communication scheme that is advanced through CDMA and CDMA-2000, to be UMB. Embodiments of the present invention may not be limited to a specific wireless communication field, and may be applicable to all technical fields to which a technical idea of the present invention is applicable.

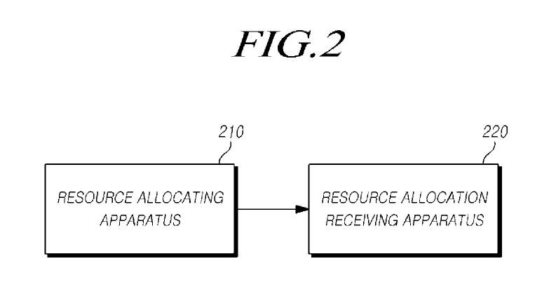

FIG. 2 is a diagram illustrating a resource allocating apparatus 210 and a resource allocation receiving apparatus 220 for resource allocation in a wireless communication system. The resource allocating apparatus 210 may be a resource allocating apparatus in the base station 20 of FIG. 1, and the resource allocation receiving apparatus 220 may be a resource allocation receiving apparatus in the user equipment 10 of FIG. 1.

The resource allocating apparatus 210 may generate resource allocation information allocated to the user equipment 10 in one or more resources of the frequency and time resources, and may transfer the generated resource allocation information to the resource allocation receiving apparatus 220.

For example, in 3rd Generation Partnership Project Long Term Evolution (3GPP LTE), the resource allocating apparatus 210 may transfer control information for uplink/downlink communication and resource allocation information allocated to each user equipment 10 in the frequency and time resources, through a Physical Downlink Control Channel (hereinafter referred to as “PDCCH”) transmitted in a downlink.

A resource region for resource allocation may be formed based on a time-frequency unit of a resource block (RB). In the case of a broadband, a number of resource blocks may increase and an amount of bits required for indicating the resource allocation information may also increase and thus, the resource allocation information may be processed based on a resource block group (RBG) formed of a few resource blocks. The resource allocation information expressed based on the resource blocks or the resource block groups may be transmitted in a form of Resource Indication Value (RIV) in a resource allocation field included in a PDCCH. Bandwidths considered in LTE may be 1.4/3/5/10/15/20 MHz. When the bandwidths are expressed based on a number of resource blocks, the bandwidths may correspond to 6/15/25/50/75/100, respectively. Sizes (P) of resource block groups expressed by corresponding resource blocks in respective bands may be 1/2/2/3/4/4, respectively. Therefore, a number of resource block groups for each band may be 6/8/13/17/19/25.

Based on a scheme that expresses a way of resource allocation to a resource allocation field, there may be varied types of resource allocation schemes (Type 0, Type 1, and Type 2).

From among the varied types of resource allocation schemes, Type 0 may correspond to a scheme that indicates a resource allocation region based on a bitmap format. That is, resource allocation may be expressed to be 1, and non-resource allocation may be expressed to be 0 for each resource block or each resource block group, so as to indicate resource allocation with respect to the entire band. When a number of resource blocks is n, an amount of bits required for expressing the resource allocation based on Type 0 may be

$$⌈ \frac{n}{P} ⌉ .$$

Type 1, another resource allocation scheme, may correspond to a scheme that indicates a resource allocation region based on a periodic format. That is, type 1 may indicate resource allocation having a period of P and in a form of distributions at regular intervals in the entire allocation region, and may set ┌log₂(P)┐ bits to indicate a size of a subset having the period, may set 1 bit to indicate an offset, and may set

$$⌈ \frac{n}{P} ⌉ - ⌈ {log}_{2} ( P ) ⌉ - 1$$

to indicate predetermined resource allocation. Type 1 may be designed to use the same amount of bits as type 0. In general, when type 0 and type 1 are used together, a differentiation bit to distinguish type 0 and type 1 may be added.

Type 2, as another resource allocation scheme, may correspond to a scheme that is used to allocate a contiguous resource region having a predetermined length. Type 2 may be expressed based on an offset at a starting point (a point before the start) of the entire resource allocation region and a length of the resource allocation region (referred to as a “cluster”). Unlike type 0 and type 1 that indicate noncontiguous resource allocation, type 2 may indicate and require only a contiguous resource region and thus, an amount of bits required may be less than type 0 and type 1 when a large number of resource blocks is used in a system that uses a wide band. The amount of bits required may be

$$⌈ {log}_{2} \frac{n ( n + 1 )}{2} ⌉ .$$

Therefore, other resource allocation schemes (that is, Type 0 and Type 1) may express resource allocation based on a resource block group format, whereas type 2 may express the resource allocation based on a resource block format. The resource allocation scheme of Type 0 of FIG. 1 may correspond to the resource allocation scheme of Type 2 that allows a cluster having a single resource block (or resource block group) and has 6 clusters. Also, the resource allocation scheme of Type 1 of FIG. 2 may correspond to the resource allocation scheme of Type 2 in which an offset of each cluster is 1 and a cluster length is 1.

In association with Type 2 as described in the foregoing, only the resource allocation scheme of Type 2 having a single contiguous block may be applicable to a uplink, and uplink resource allocation based on a plurality of non-contiguous blocks (that is, a plurality of clusters) may be applicable. The resource allocation may be referred to as “Non-Contiguous Resource Allocation”, and each block in the plurality of non-contiguous blocks may be referred to as a cluster. Type 0 may express the non-contiguous resource allocation. However, the resource allocation of Type 0 enables all available non-contiguous allocation in the entire range of given resource block groups, whereas the non-contiguous resource allocation may consider only a predetermined number of clusters (for example, 2 through 4 clusters). In the case where the number of clusters is limited, signaling overhead for resource allocation may be required more than the clustering effect when the number of clusters is greater than a predetermined number (for example: 4) and thus, a gain through the resource allocation may become meager.

There may be varied schemes for coding/decoding of an RIV for non-contiguous resource allocation using a limited number of clusters. One of the varied schemes may be a scheme using an Enumerative Source Coding.

Here, the scheme using the enumerative source coding is already included in the existing LTE standard as a scheme of indicating a Channel Quality Indicator and thus, the scheme may be readily standardized and may decrease complexity and may secure a stable embodiment in terms of the extension of a previously embodied system. For the channel quality indicator, the enumerative source coding may indicate a scheme that is performed based on a frequency unit of a subband, and expresses selection of a predetermined number (N) of subbands from a given subband region (1 through N). The enumerative source coding may be expressed as follows.

A value may be calculated with respect to N subband indices {sₖ}ₖ₌₀^{M-1}, (1≦sₖ≦N, sₖ<sₖ₊₁) aligned in ascending order.

$$r = {\sum }_{k = 0}^{M - 1} 〈 \begin{matrix}N - {s}_{k} \\ M - k\end{matrix} 〉$$

$$here , 〈 \begin{matrix}x \\ y\end{matrix} 〉 = \{ \begin{matrix}( \begin{matrix}x \\ y\end{matrix} ) = {}_{x}^{}{C}{}_{y}^{} & x \geq y \\ 0 & x < y\end{matrix} , \\ r ∈ \{ 0 , … , ( \begin{matrix}N \\ M\end{matrix} ) - 1 \} .$$

A decoding process for the above will be expressed as follows.

```
xₘᵢₙ = 1
for k = 0 to M − 1,
  x = xₘᵢₙ
  $p = 〈 \begin{matrix}N - x \\ M - k\end{matrix} 〉$
  while p > r,
    x = x + 1
    $p = 〈 \begin{matrix}N - x \\ M - k\end{matrix} 〉$
  end
  sₖ = x
  xₘᵢₙ = sₖ + 1
  r = r − p
end
```

In the resource allocation scheme using a limited number of clusters, various schemes may be available. The resource allocation scheme may have an RIV form that is different from the RIV form of Type 0, Type 1, and Type 2 when resource allocation information is inserted into a resource allocation field in an RIV form and transmitted through a physical downlink control channel. For this, a scheme of configuring a new downlink control indication format may be possible. It is desirable that the new DCI format is configured to have the same size as an existing DCI format. In LTE, a received physical downlink control channel is decoded based on a blind decoding. The blind decoding performs decoding based on a size of the DCI format, since a number of blind decodings to be performed increases when a new DCI format having a different size is introduced. It is desirable to decrease the number of blind decodings since the blind decoding is associated with a system complexity, an amount of calculation required, and an amount of power consumption. Therefore, the DCI format may need to be configured to have the same size as the existing DCI format, and it is desirable to extend the existing DCI format. One of schemes considered in 3GPP LTE-A is a scheme that extends the DCI format 0. The DCI format 0 includes 1 bit that is not used, and the scheme may use the bit to distinguish the existing DCI format 0 (resource allocation Type 0) and a newly introduced non-contiguous cluster for the extension. When the existing DCI format 0 is used in this manner, under an assumption that a frequency hopping is not used for non-contiguous clusters, an existing bit indicating whether frequency hopping is performed may be added to a resource allocation field and may be used for the non-contiguous resource allocation. In a band of 20 MHz, 14 bits, that is, Type 0 allocation bits of 13 bits and a frequency hopping indication bit of 1 bit are configured with respect to 100 resource blocks. 14 bits may express two clusters having the complete degree of freedom (expressed by resource block groups and expressed by 25 resource block groups). That is, it is the case in which an amount of allocated bits of an existing format is insufficient for expressing two or more clusters, and more clusters may need to be expressed.

To express more clusters, it is suggested that limitation needs to be put on configuration of a cluster. One of the suggestions insists that a limitation that limits the sizes of all clusters to be identical to each other is needed when a plurality of clusters are allocated. In the case where the sizes (that is, cluster lengths) of all clusters are identical, a signaling with respect to two and three clusters may be expressed by 13 bits when the cluster is configured of 25 resource block groups in 20 MHz.

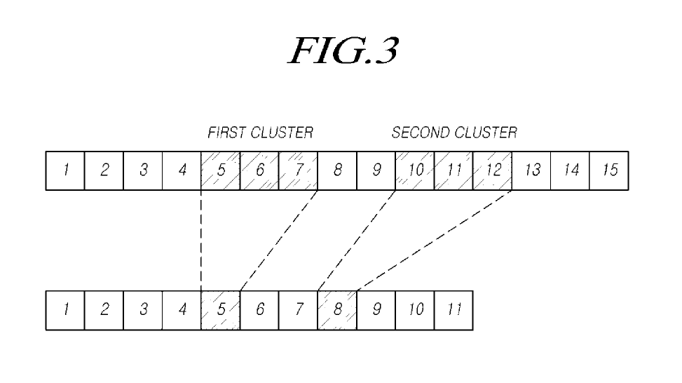

As described in the forgoing, varied types of resource allocation schemes that may be provided by the apparatus 210 have been described. Hereinafter, as a resource allocation method that requires a smaller amount of bits when compared to other resource allocation schemes, a resource allocation method with respect to clusters having an identical cluster length will be described with reference to FIG. 3.

FIG. 3 is a diagram illustrating an example of resource allocation according to an embodiment of the present invention.

FIG. 3 illustrates an example of the case in which resources are allocated to two clusters (a first cluster and a second cluster) having a cluster length of 3 in a total of 15 resource block groups.

In this example, a number of all events of resource allocation may correspond to a number of events that consider a cluster formed of three resource block groups as a single resource block group and selects two resource block groups from the entire resource block groups. That is, a cluster having a length of 3 resource block groups, that is, a cluster having a cluster length of 3, is considered to be a single resource block group (hereinafter referred to as a “substitute resource block group”) and a number of the entire resource block groups is decreased to 11 and thus, the number of all events of the resource allocation may be obtained based on a number of all events that select 2 resource block groups from a total of 11 resource block groups. That is, this may correspond to ₁₁C₂. Therefore, when the cluster length is considered in ascending order from 1, the number of all events of the resource allocation may be expressed based on Equation 1.

$${RIV}^{max} ( n , x , k ) = {\sum }_{i = 1}^{x} 〈 \begin{matrix}n - ki + k \\ k\end{matrix} 〉 \\ 〈 \begin{matrix}x \\ y\end{matrix} 〉 = \{ \begin{matrix}( \begin{matrix}x \\ y\end{matrix} ) = {}_{x}^{}{C}{}_{y}^{} & x \geq y \\ 0 & x < y\end{matrix} \qquad [ Equation 1 ]$$

In Equation 1, n denotes a number of entire resource block groups, k denotes a number of clusters, and x denotes a cluster length. i is a value included in a range between 1 through x, and indicates that the cluster length is considered from 1 through x. RIV^{max}(n,x,k) defined by the values may indicate a number of events that perform resource allocation with respect to k clusters having a cluster length of x in a total of n resource block groups.

Equation 1 may be applied to the example of the resource allocation of FIG. 2. In FIG. 2, when the cluster length is considered in an ascending order from 1, a number of all events of resource allocation may be calculated by adding a number of events that perform resource allocation with respect to 2 clusters having a cluster length of 1 in a total of 15 resource block groups, a number of events that perform resource allocation with respect to 2 clusters having a cluster length of 2 in the total of 15 resource block groups, and a number of events that perform resource allocation with respect to 2 clusters having a cluster length of 3 in the total of 15 resource block groups, as given below.

$$\begin{matrix}{RIV}^{max} ( 15 , 3 , 2 ) = 〈 \begin{matrix}15 - 2 ( 1 - 1 ) \\ 2\end{matrix} 〉 + 〈 \begin{matrix}15 - 2 ( 2 - 1 ) \\ 2\end{matrix} 〉 + 〈 \begin{matrix}15 - 2 ( 3 - 1 ) \\ 2\end{matrix} 〉 \\ = 〈 \begin{matrix}15 \\ 2\end{matrix} 〉 + 〈 \begin{matrix}13 \\ 2\end{matrix} 〉 + 〈 \begin{matrix}11 \\ 2\end{matrix} 〉 \\ = {}_{15}^{}{C}{}_{3}^{} + {}_{13}^{}{C}{}_{2}^{} + {}_{11}^{}{C}{}_{2}^{}\end{matrix}$$

Referring to FIG. 3, the resource allocating apparatus 210 may code 15 corresponding to the number of entire resource block groups, 5 and 10 respectively corresponding to start resource block group information (that is, starting values) of 2 clusters, 3 corresponding to the cluster length, 2 corresponding to the number of clusters, and the like, so as to generate resource allocation information, and may transmit the generated resource allocation information to the resource allocation receiving apparatus 220. In this example, due to 15 corresponding to the number of entire resource block groups, an amount of bits of the generated resource allocation information may be increased.

Therefore, the resource allocation method according to an embodiment of the present invention may replace each cluster with a single resource block group and thus, may reduce the number of entire resource block groups from 15 to 11, may code 5 and 8 corresponding to information (that is, substitute resource block group information) modified from 5 and 10 respectively corresponding to the start resource block group information (that is, starting values) of 2 clusters, may generate resource allocation information, and may transmit the generated resource allocation information to the resource allocation receiving apparatus 220, and thus, an amount of bits of the generated resource allocation information may be dramatically reduced.

In other words, according to the resource allocation method according to an embodiment of the present invention, when resource allocation is performed with respect to a cluster including two or more resource block groups and having a cluster length of at least 2, the cluster having the length of at least 2 may be considered to be a cluster having a length of 1, that is, a single resource block group (hereinafter referred to as a “substitute resource block group”) and thus, the number of entire resource block groups may be reduced. Based on the fact that an amount of bits of generated resource allocation information increases as the number of entire resource block groups increases, the reduction in the number of entire resource block groups may decrease the amount of bits of the generated resource allocation information.

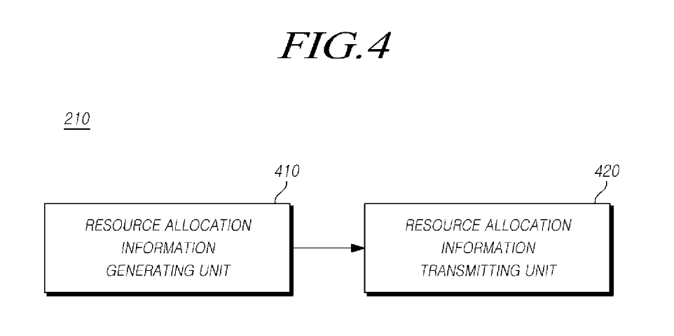

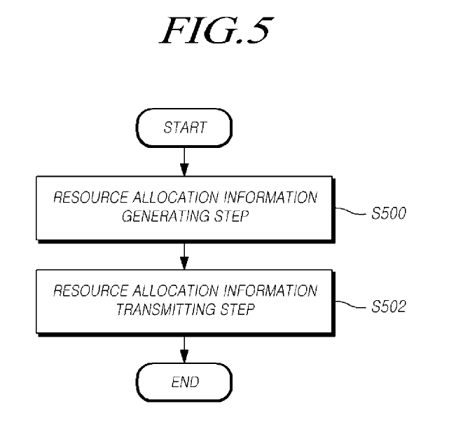

As described in the foregoing, an example of the resource allocation method according to an embodiment of the present invention has been described. Hereinafter, a resource allocation method and apparatus that generates and transmits resource allocation information for providing the resource allocation method according to an embodiment of the present invention will be described with reference to FIGS. 4 and 5.

FIG. 4 is a diagram illustrating the resource allocating apparatus 210 according to an embodiment of the present invention.

Referring to FIG. 4, the resource allocating apparatus 210 according to an embodiment of the present invention may include a resource allocation information generating unit 410 to generate resource allocation information, a resource allocation information transmitting unit 420 to transmit the generated resource allocation information to a resource allocation receiving apparatus, and the like.

The resource allocation information generating unit 410 may replace each cluster including two or more resource block groups with a single substitute resource block group so as to reduce a number of entire resource block groups, and may generate resource allocation information based on the decreased number of entire resource block groups, a number of clusters, and information associated with a substitute resource block group that is substituted for each cluster, when resource allocation is performed with respect to one or more clusters having an identical cluster length in the entire resource block groups.

The resource block group may include one or more resource blocks. That is, the resource block group may correspond to a single resource block or may correspond to a resource block group including two or more resource blocks.

The decreased number of entire resource block groups used when the resource allocation information is generated may be a value that is reduced from the original number of entire resource block groups, by replaying each cluster with a single substitute resource block group, and may correspond to a value obtained by subtracting, from the number of entire resource block groups, a value obtained by multiplying a value obtained by subtracting 1 from the cluster length and the number of clusters. That is, when the number of entire resource block groups before the reduction is n, the cluster length is x, and the number of clusters is k, the decreased number of entire resource block groups may be [symbol] n−k(x−1) [symbol] . Referring to FIG. 3, when the number of entire resource block groups before the reduction n is 15, the cluster length x is 3, and the number of clusters k is 2, the decreased number of entire resource block groups may be 15−2(3−1)=11. The number of entire resource block groups is decreased and thus, a coded value obtained through following Equations may become smaller and an amount of bits of resource allocation information transmitted for the resource allocation may be decreased.

The substitute resource block group information used for generating the resource allocation information may correspond to information associated with a single resource block group (substitute resource block group) that substitutes each cluster to which resource allocation is performed and that has an identical cluster length, may correspond to start resource block group information of each cluster, or may correspond to modified start resource block group information of each cluster that is modified since each cluster is replaced with a single substitute resource block group and the number of entire resource block groups is decreased. The substitute resource block group information may be expressed, for example, by Equation 2.

Sⱼ=S′ⱼ−j·(x−1) [Equation 2]

In Equation 2, x denotes a cluster length, and j denotes an order of a cluster and satisfies 0≦j≦k−1. sⱼ denotes information associated with a substitute resource block group that substitutes a j^{th} cluster, s′ⱼ denotes information associated with a start resource block group of a j^{th} cluster before the j^{th} cluster is replaced with a single substitute resource block group, and a relationship between sⱼ and s′ⱼ may be expressed by Equation 2.

Referring to FIG. 3, when the start resource block group information s′₀ and s′₁ before the reduction of 2 clusters (before replacement with substitute resource block groups) are 5 and 10, respectively, the substitute resource block group information s₀ and s₁ after the reduction of 2 clusters (after replacement with a substitute resource block groups) may be calculated based on Equation 2. s₀ may correspond to 5−0(3−1)=5 and s₁ may correspond to 10-1(3−1)=8.

The resource allocation information generating unit 310 may code the decreased number of entire resource block groups (n−k(x−1)), the number of clusters (k), the information associated with a substitute block group that substitutes each cluster (sⱼ, 0≦j≦k−1), and the like, and may generate resource allocation information based on the coded value. Here, the coding may correspond to an Enumerative Source Coding. The resource allocation information generated based on the coded value may be expressed by Equation 3.

$$\begin{matrix}RIV ( n , x , {s}_{0} , … , {s}_{k - 1} ) = Code \\ = {\sum }_{j = 0}^{k - 1} 〈 \begin{matrix}n - kx + k - {s}_{j} \\ k - j\end{matrix} 〉\end{matrix} \qquad [ Equation 3 ]$$

In Equation 3, n denotes a number of entire resource block groups, k denotes a number of clusters, x denotes a cluster length, and sⱼ denotes information associated with a substitute resource block group that substitutes a j^{th} cluster.

The resource allocating apparatus 210 may need to inform the resource allocation receiving apparatus 220 of an identical cluster length (x) of each cluster, in addition to informing the resource allocation receiving apparatus 220 of a starting value of each cluster (that is, substitute resource block group information).

Therefore, the resource allocating apparatus 210 may generate, based on Equation 3, the resource allocation information by adding, to the coded value, predetermined information that enables the resource allocation receiving apparatus 220 that receives the generated resource allocation information to recognize the cluster length (x).

When the number of clusters (k) corresponds to a predetermined value, the resource allocation information generating unit 310 may generate the resource allocation information by adding, to the coded value, information (hereinafter referred to as “first offset information (1stOffset)”) that enables the resource allocation receiving apparatus 220 to recognize the cluster length. Here, the first offset information (1stOffset) that enables the cluster length to be recognized may correspond to a number of all events that generate a cluster of which a length is shorter than the cluster length from the entire resource block groups.

As described in the foregoing, when the number of clusters (k) corresponds to a predetermined value, the resource allocation information generating unit 310 may generate, based on Equation 4, the resource allocation information by adding, to the coded value, the first offset information (1stOFfset) that enables the resource allocation receiving apparatus 220 to recognize the cluster length.

$$\begin{matrix}RIV ( n , x , {s}_{0} , … , {s}_{k - 1} ) = 1 stOffset + Code \\ = {\sum }_{i = 1}^{x - 1} 〈 \begin{matrix}n - ki + k \\ k\end{matrix} 〉 + \\ {\sum }_{j = 0}^{k - 1} 〈 \begin{matrix}n - kx + k - {s}_{j} \\ k - j\end{matrix} 〉\end{matrix} \qquad [ Equation 4 ]$$

When the number of clusters (k) corresponds to a value included in a predetermined range, the resource allocation information generating unit 310 may generate the resource allocation information by adding information that enables the resource allocation receiving apparatus 220 to recognize the number of clusters (k) (hereinafter referred to as “second offset information (2ndOffset)”) to a value (a value obtained from Equation 4) obtained by adding the first offset information (1stOffset) and the coded value. Here, the second offset information corresponds to information that enables the resource allocation receiving apparatus 220 to recognize the number of clusters (k), and may correspond to a number of all events that generate a smaller number of clusters than the number of clusters from the entire resource block groups. As described in the foregoing, when the resource allocation information is generated based on the second offset information, the resource allocation information may be expressed by Equation 5.

$$\begin{matrix}{RIV}^{multi} ( n , x , k ) = 2 ndOffset + RIV ( n , x , {s}_{0} , … , {s}_{k - 1} ) \\ = {\sum }_{l = {k}_{s}}^{k - 1} {RIV}^{max} ( n , {x}_{l}^{max} , l ) + \\ RIV ( n , x , {s}_{0} , … , {s}_{k - 1} )\end{matrix} \\ {RIV}^{max} ( n , x , k ) = {\sum }_{i = 1}^{x} 〈 \begin{matrix}n - ki + k \\ k\end{matrix} 〉 \\ {x}_{k}^{max} = ⌊ \frac{n - k + 1}{k} ⌋ \qquad [ Equation 5 ]$$

In Equation 5, xₖ^{max} denotes a maximum value of a cluster length. Also, ks denotes a number of clusters started within a considered range of clusters, and generally has a value of 1 or 2 and the like.

The resource allocation scheme described in the foregoing may be applied to a downlink. When the resource allocation scheme is applied to an uplink, the cluster length may be limited. The cluster length corresponding to a number of resource block groups included in each cluster may be limited to a value calculated from 2^{α}3^{β}5^{γ}(a≧0, β≧0, γ≧0) when the resource allocation information to be generated corresponds to resource allocation information for the uplink. Accordingly, the cluster length may be expressed by a set corresponding to K={y|y=2^{α}3^{β}5^{γ}, a≧0, β≧0, γ≧0}. In the case where the cluster length x is an element of the set K, that is, xεK, when the limitation is applied, Equation 1 and Equation 4 may be expressed by Equation 6 and Equation 7, as follows.

$$\begin{matrix} {RIV}^{max} ( n , x , k ) = {\sum }_{i = 1 , i ∈ K}^{x} 〈 \begin{matrix}n - ki + k \\ k\end{matrix} 〉 & [ Equation 6 ] \\ RIV ( n , x , {s}_{0} , … , {s}_{k - 1} ) = {\sum }_{i = 1 , i ∈ K}^{x - 1} 〈 \begin{matrix}n - ki + k \\ k\end{matrix} 〉 + {\sum }_{j = 0}^{k - 1} 〈 \begin{matrix}n - kx + k - {s}_{j} \\ k - j\end{matrix} 〉 & [ Equation 7 ]\end{matrix}$$

As described in the foregoing, the resource allocating apparatus 210 that generates resource allocation information of a small amount of bits by allocating resources to clusters having an identical cluster length (K) has been described. Hereinafter, a resource allocation method provided by the resource allocating apparatus 210 will be described with reference to FIG. 5.

FIG. 5 is a flowchart illustrating a resource allocation method according to an embodiment of the present invention.

As described in FIG. 5, the resource allocation method according to an embodiment of the present invention may include a resource allocation information generating step (step S500) to generate resource allocation information, a resource allocation information transmitting step (step S502) to transmit the generated resource allocation information to a resource allocation receiving apparatus, and the like.

The resource allocation information generating step (step S500) may replace each cluster including two or more resource block groups with a single substitute resource block group so as to reduce a number of entire resource block groups, and may generate resource allocation information based on the decreased number of entire resource block groups, a number of clusters, and information associated with a substitute resource block group that substitutes each cluster, when resource allocation is performed with respect to one or more clusters having an identical cluster length in the entire resource block groups.

In the resource allocation information generating step (step S500), the decreased number of entire resource block groups used for generating the resource allocation information may be a value that is reduced from the original number of entire resource block groups by replacing each cluster with a single substitute resource block group, and may correspond to a value obtained by subtracting, from the number of entire resource block groups, a value obtained by multiplying a value obtained by subtracting 1 from the cluster length and the number of clusters. That is, when the number of entire resource block groups before the reduction is n, the cluster length is x, and the number of clusters is k, the decreased number of entire resource block groups may be [symbol] n−k(x−1) [symbol] .

In the resource allocation information generating step (step S500), the substitute resource block group information used for generating the resource allocation information may correspond to information associated with a single resource block group (substitute resource block group) that substitutes each cluster to which resource allocation is performed and that has an identical cluster length, may correspond to start resource block group information of each cluster, or may correspond to modified start resource block group information of each cluster that is modified since each cluster is replaced with a single substitute resource block group and the number of entire resource block groups is decreased

The resource allocation information generating step (step S500) may code the decreased number of entire resource block groups (n−k(x−1)), the number of clusters (k), the information associated with a substitute block group that substitutes each cluster (sⱼ, 0≦j≦k−1), and the like, and may generate resource allocation information based on the coded value. Here, the coding may correspond to an Enumerative Source Coding. The resource allocation information generated based on the coded value may be expressed by Equation 3.

The resource allocation information generating step (step S500) may generate, based on Equation 3, the resource allocation information by adding, to the coded value, predetermined information that enables the resource allocation receiving apparatus 220 that receives the generated resource allocation information to recognize the cluster length (x).

When the number of clusters (k) corresponds to a predetermined value, the resource allocation information generating step (step S500) may generate, based on Equation 4, the resource allocation information by adding, to the coded value, information (hereinafter referred to as “first offset information (1stOffset)”) that enables the resource allocation receiving apparatus 220 to recognize the cluster length. Here, the first offset information (1stOffset) that enables the cluster length to be recognized may correspond to a number of all events that generate a cluster of which a length is shorter than the cluster length from the entire resource block groups.

When the number of clusters (k) corresponds to a value included in a predetermined range, the resource allocation information generating step (step S500) may generate, based on Equation 5, the resource allocation information by adding information that enables the resource allocation receiving apparatus 220 to recognize the number of clusters (k) (hereinafter referred to as “second offset information (2ndOffset)”) to a value (a value obtained from Equation 4) obtained by adding the first offset information (1stOffset) and the coded value. Here, the second offset information corresponds to information that enables the resource allocation receiving apparatus 220 to recognize the number of clusters (k), and may correspond to a number of all events that generate a smaller number of clusters than the number of clusters from the entire resource block groups.

The resource allocation scheme described in the foregoing may be applied to a downlink. When the resource allocation scheme is applied to an uplink, the cluster length may be limited. The cluster length corresponding to a number of resource block groups included in each cluster may be limited to a value calculated from 2^{α}3^{β}5^{γ}(a≧0, β≧0, γ≧0) when the resource allocation information to be generated corresponds to resource allocation information for the uplink. Accordingly, the cluster length may be expressed by a set corresponding to K={y|y=2^{α}3^{β}5^{γ}, a≧0, β≧0, γ≧0}. When the cluster length x is an element of the set K, that is, xεK, the resource allocation information generating step (step S500) may generate the resource allocation information based on Equation 6 and Equation 7.

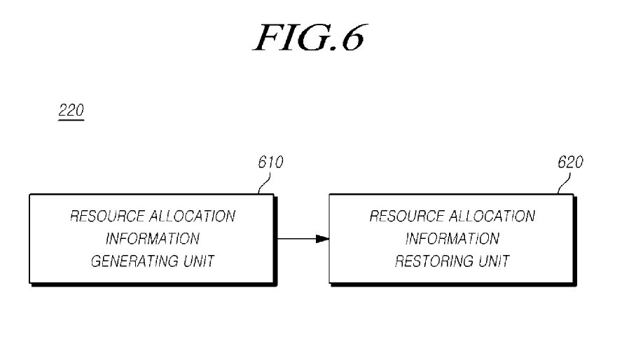

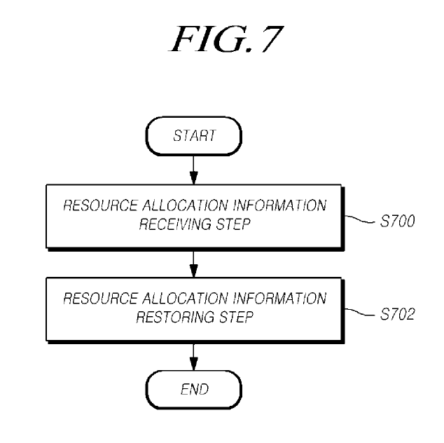

As described in the foregoing, the resource allocating apparatus 210 that generates resource allocation information of a small amount of bits by allocating resources to clusters having an identical cluster length (K) and the resource allocation method thereof have been described. Hereinafter, a resource allocation receiving apparatus 220 that receives resource allocation information transmitted from the resource allocating apparatus 210 and a resource allocation receiving method thereof will be described with reference to FIGS. 6 and 7.

FIG. 6 is a diagram illustrating the resource allocation receiving apparatus 220 according to an embodiment of the present invention.

As illustrated in FIG. 6, the resource allocation receiving apparatus 220 according to an embodiment of the present invention may include a resource allocation information receiving unit 610 to receive resource allocation information transmitted by the resource allocating apparatus 210, a resource allocation information restoring unit 620 to restore the received resource allocation information so as to determine how resource allocation is performed by the resource allocating apparatus 210, and the like.

The resource allocation information receiving unit 610 may receive, from the resource allocating apparatus 210, the resource allocation information generated based on a number of entire resource block groups that is decreased by replacing, with a single substitute resource block group, each cluster to which resource allocation is performed and that includes two or more resource block groups and has an identical cluster length, a number of clusters, and substitute resource block group information. The resource allocation information received by the resource allocation information receiving unit 610 may be expressed by one of Equation 3, Equation 4, Equation 5, Equation 7, and the like. The resource block group may include one or more resource blocks.

The resource allocation information restoring unit 620 may recognize the cluster length and the substitute resource block group information from the resource allocation information received by the resource allocation information receiving unit 610, may restore start resource block group information of each cluster based on the recognized cluster length (x) and the recognized substitute resource block group information (sⱼ, 0≦j≦k−1), and may restore end resource block group information of each cluster based on the restored start resource block group information of each cluster and the cluster length.

When the number of clusters is included in a predetermined range, the resource allocation information restoring unit 620 may compare, with second offset information included in the resource allocation information, a number of events of a cluster that is generated from the entire resource block groups based on a number of clusters, so as to recognize a number of clusters, and may recognize a number of clusters having a predetermined value in the predetermined range.

Accordingly, the resource allocation information restoring unit 620 may obtain resource allocation information associated with the number of clusters having the predetermined value by subtracting the second offset information from the received resource allocation information, in the process of recognizing the number of clusters. The resource allocation information associated with the number of clusters having the predetermined value may include first offset information that enables the cluster length to be recognized. Therefore, the resource allocation information restoring unit 620 may compare a number of events of a cluster that is generated from the entire resource block groups for each cluster length with the first offset information included in the resource allocation information obtained in association with the number of clusters having the predetermined value, so as to recognize the cluster length.

The resource allocation information restoring unit 620 may obtain a coded value by subtracting the first offset information from the resource allocation information obtained in association with the number of clusters having the predetermined value in the process of recognizing the cluster length, and may recognize the substitute resource block group information (sⱼ, 0≦j≦k−1) by decoding the coded value.

In this example, the recognized substitute resource block group information may correspond to start resource block group information of each cluster or may correspond to modified start resource block group information of each cluster that is modified since each cluster is replaced with a single substitute resource block group and the number of entire resource block groups is reduced.

Also, the coded value to be decoded may be a value coded by the resource allocating apparatus 210 using the decreased number of entire resource block groups, the number of clusters, and the information associated with a substitute resource block group that substitutes each cluster, and may correspond to a value coded by an Enumerative Source Coding.

As described in the foregoing, the resource allocation receiving apparatus 220 that receives and restores the resource allocation information and determines how the resource allocation is performed has been described. Hereinafter, a resource allocation receiving method provided by the resource allocation receiving apparatus 220 will be described with reference to FIG. 7.

FIG. 7 is a flowchart illustrating a resource allocation receiving method according to an embodiment of the present invention.

As illustrated in FIG. 7, the resource allocation receiving method according to an embodiment of the present invention includes a resource allocation information receiving step (step S700) to receive resource allocation information transmitted by the resource allocating apparatus 210, a resource allocation information restoring step (step S702) to restore the received resource allocation information so as to determine how the resource allocation is performed by the resource allocating apparatus 210, and the like.

The resource allocation information receiving step (step S700) may receive the resource allocation information generated based on a number of entire resource block groups that is decreased by replacing, with a single substitute resource block group, each cluster to which resource allocation is performed and that includes two or more resource block groups and has an identical cluster length, a number of clusters, and substitute resource block group information.

The resource allocation information restoring step (step S702) may recognize the cluster length and the substitute resource block group information from the received resource allocation information, may restore start resource block group information of each cluster based on the cluster length and the substitute resource block group information, and may restore end resource block group information of each cluster based on the restored start resource block group information of each cluster and the cluster length.

When the number of clusters is included in a predetermined range, the resource allocation information restoring step (step S702) may compare, with second offset information included in the resource allocation information, a number of events of a cluster that is generated from the entire resource block groups based on a number of clusters, so as to recognize a number of clusters, and may recognize a number of clusters having a predetermined value in the predetermined range.

Accordingly, the resource allocation information restoring step (step S702) may obtain resource allocation information associated with the number of clusters having the predetermined value by subtracting the second offset information from the received resource allocation information, in the process of recognizing the number of clusters. The resource allocation information associated with the number of clusters having the predetermined value may include first offset information that enables the cluster length to be recognized. Therefore, the resource allocation information restoring step (step S702) may compare a number of events associated with a cluster that is generated from the entire resource block groups for each cluster length with the first offset information included in the resource allocation information obtained in association with the number of clusters having the predetermined value, so as to recognize the cluster length.

The resource allocation information restoring step (step S702) may obtain a coded value by subtracting the first offset information from the resource allocation information obtained in association with the number of clusters having the predetermined value in the process of recognizing the cluster length, and may recognize the substitute resource block group information (sⱼ, 0≦j≦k−1) by decoding the coded value.

In this example, the recognized substitute resource block group information may correspond to start resource block group information of each cluster or may correspond to modified start resource block group information of each cluster that is modified since each cluster is replaced with a single substitute resource block group and the number of entire resource block groups is reduced.

Also, the coded value to be decoded may be a value coded by the resource allocating apparatus 210 using the decreased number of entire resource block groups, the number of clusters, and the information associated with a substitute resource block group that substitutes each cluster, and may correspond to a value coded by an Enumerative Source Coding.

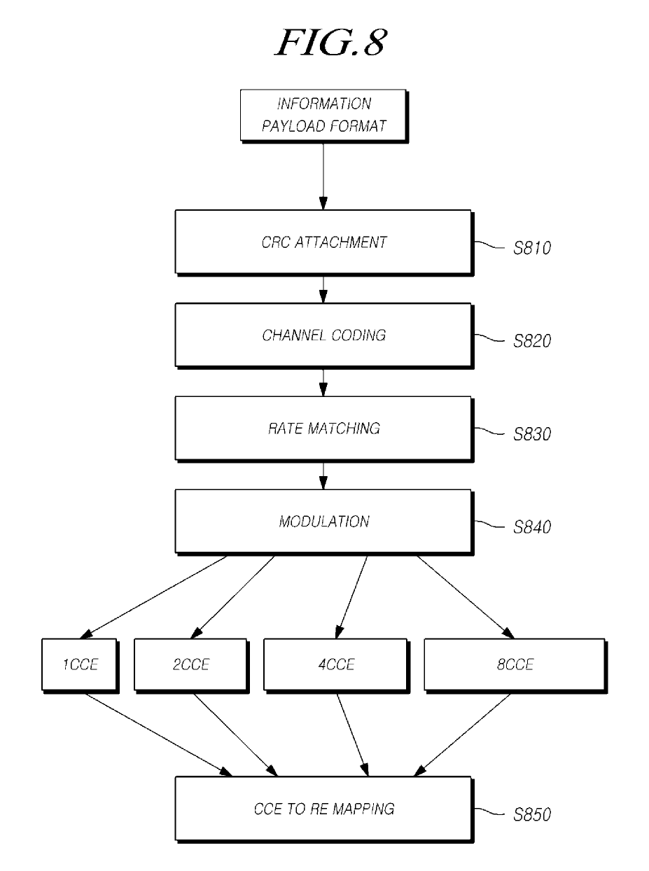

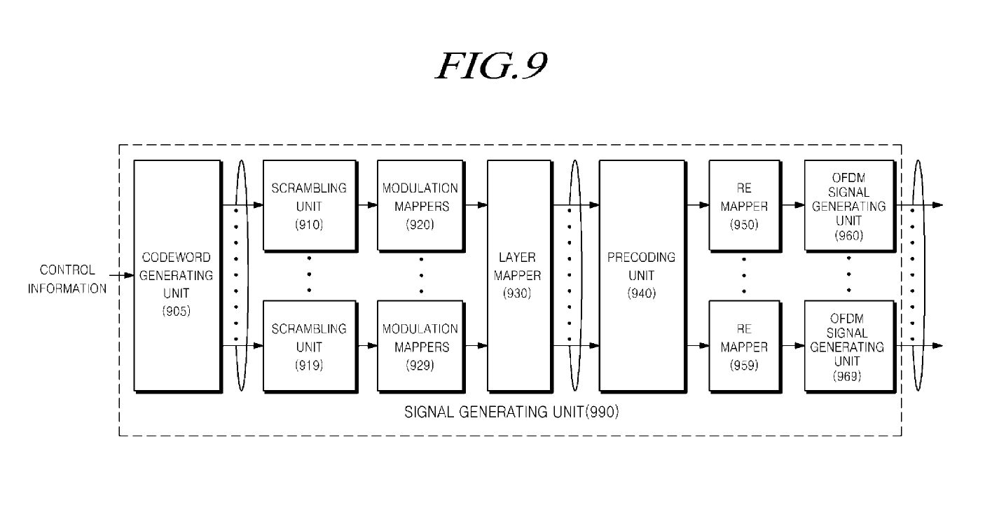

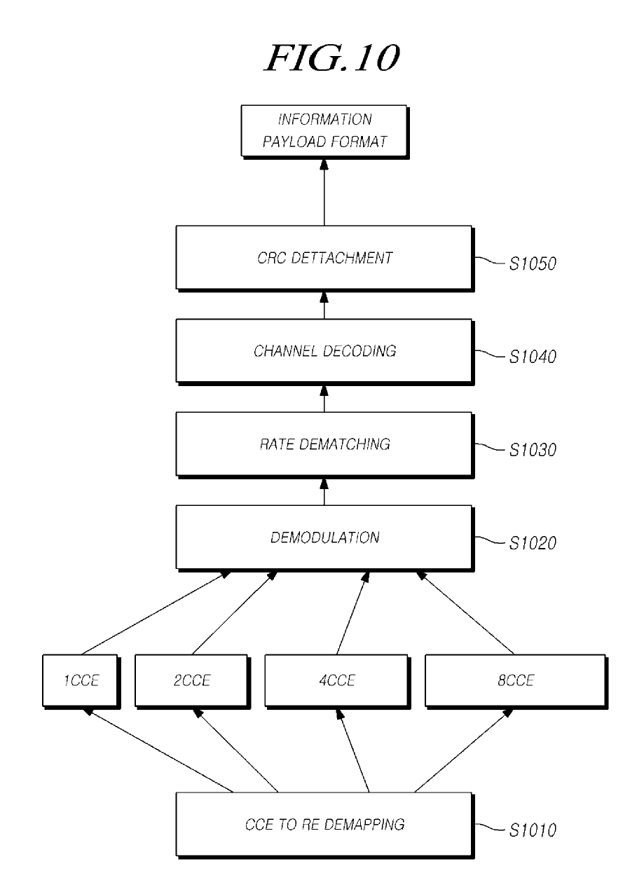

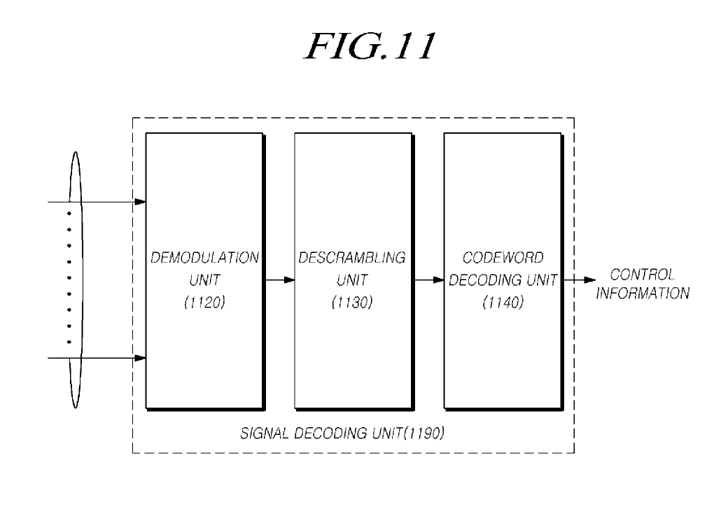

FIG. 8 is a flowchart illustrating a configuration of a PDCCH according to another embodiment of the present invention. FIG. 10 is a flowchart illustrating PDCCH processing according to another embodiment of the present invention. FIGS. 9 and 11 are block diagrams illustrating a transmitting apparatus of a base station and a receiving apparatus of a user equipment.

Referring to FIGS. 1 through 8, the base station 20 may configure a PDCCH payload based on information payload format to be transmitted to a user equipment. The length of the PDCCH payload may vary based on the information payload format. The information payload format may correspond to a DCI format.

As described in the foregoing, the DCI format 0 may be configured by expressing an RIV on a resource allocation field of the DCI format 0. In this example, although the resource allocation field may express the RIV based on the schemes described with reference to FIGS. 2 through 7, detailed descriptions thereof will be omitted to avoid redundant description. A different information payload format may exist as a DCI format.

In step S801, a Cyclic Redundancy Check (CRC) for error detection may be added to each PDCCH payload. Based on an owner or a user of a PDCCH, an identifier (referred to as a Radio Network Temporary Identifier (RNTI)) may be masked on the CRC.

In step S820, coded data may be generated by performing channel coding on the CRC-added control information.

In step S830, rate matching may be performed based on a CCE aggregation level allocated to a PDCCH format.

In step S840, modulated symbols may be generated by modulating the coded data.

In step S850, the modulated symbols may be mapped to a physical resource element (CCE to RE mapping).

The control information transmitting method described with reference to FIG. 8 may be generalized as follows. A base station may transmit control information to a user equipment by performing a step of adding a Cyclic Redundancy Check (CRC) for error detection to control information including resource allocation information expressed by Equations 3, 4, 5, and 7, a step of generating coded data by performing channel coding on the CRC-added control information, a step of generating modulated symbols by modulating the coded data, and a step of mapping the modulated symbols to a physical resource element.

FIG. 9 is a block diagram illustrating a base station that generates control information for a downlink according to another embodiment of the present invention.

Referring to FIGS. 1 through 9, a codeword generating unit 905, scrambling units 910 through 919, modulation mappers 920 through 929, a layer mapper 930, a precoding unit 940, Resource Element mappers (RE mappers) 950 through 959, and OFDM signal generating units 960 through 969 may exist as separate modules in a signal generating unit 990, and two or more modules may be coupled to operate as a single module.

Control information obtained by adding Cyclic Redundancy Check (CRC) to control information including resource allocation information expressed by Equations 3, 4, 5, and 7 may be input to the signal generating unit 990.

The CRC-added control information may be generated to be an OFDM signal through the codeword generating unit 905, the scrambling units 910 through 919, the modulation mappers 920 through 929, the layer mapper 930, the precoding unit 940, the Resource Element mappers (RE mappers) 950 through 959, and the OFDM signal generating units 960 through 969, and may be transmitted to a user equipment via an antenna.

In the process of generating the OFDM signal of FIG. 9, precoding may be omitted in the process of a PDCCH which is described with reference to FIG. 8 and thus, the input and output of the precoding may be identical. Also, multiple paths may not be performed after the codeword is generated. To generate a PDDCCH control channel, a Tailbiting Convolutional Coding (TCC) may be used, and an operation associated with Rate Matching (RM) may be applied.

The control information transmitting method and apparatus that has been described with reference to FIGS. 8 and 9 may correspond to an example that embodies the resource allocating apparatus and method that has been described with reference to FIGS. 1 through 5. The resource allocating apparatus and method that has been described with reference to FIGS. 1 through 5 may not be limited to the resource allocating apparatus and method that has been described with reference to FIGS. 8 and 9, and may be embodied by various methods and apparatuses.

FIG. 10 is a flowchart illustrating PDCCH processing.

Referring to FIGS. 1 and 10, in step S1010, the user equipment 10 may perform demapping of a CCE from a physical resource element (CCE to RE demapping).

In step S1020, the user equipment 10 may perform demodulation with respect to a CCE aggregation level that a payload corresponding to a reference DCI format associated with a transmission mode of the user equipment 10 may have, since the UE 10 is not aware of at which CCE aggregation level the UE 10 is to receive a PDCCH.

In step S1030, the user equipment 10 may perform De-Rate Matching of the demodulated data based on the corresponding payload and the CCE aggregation level.

In step S1040, the user equipment 10 may perform channel-decoding of coded data based on a code rate, and may perform CRC so as to detect whether an error occurs. When an error is not detected, it indicates that the user equipment 10 detects a corresponding PDCCH. When an error occurs, the user equipment 10 may continuously perform blind decoding with respect to another CCE aggregation level or another DCI format.

In step S1050, the user equipment 10 that detects the corresponding PDCCH may remove a CRC from the decoded data so as to obtain control information required by the user equipment 10.

In particular, the user equipment 10 may detect the DCI format 0 so as to interpret uplink scheduling grant included in the DCI format 0. In this example, the DCI format 0 may be detected, and the uplink scheduling grant included in the DCI format 0 may be interpreted by calculating an RIV through a decoding process when a resource indicator of a resource allocation field is expressed as described in the foregoing, and by calculating coefficients of the corresponding resource indicator.

The user equipment 10 may detect other DCI formats so as to perform functions of downlink scheduling assignments included in the control information and uplink scheduling grant, downlink scheduling assignments and uplink scheduling grant of a corresponding component carrier that is identified by a component carrier indicator through use of power control command information, power controlling, and the like.

The control information processing method that has been described with reference to FIG. 10 may be generalized as follows.

A user equipment may process control information by performing a step of demapping symbols from a physical resource element that receives control information from a base station, a step of generating data by demodulating the demapped symbols, a step of performing channel decoding on the demodulated data, a step of performing CRC so as to detect whether an error occurs, a step of obtaining required control information by removing CRC from the decoded data, and a step of interpreting resource allocation information expressed by Equations 3, 4, 6, and 7 from the obtained control information.

FIG. 11 is a block diagram illustrating a user equipment according to another embodiment of the present invention.

Referring to FIGS. 1 and 11, the user equipment may receive a signal from a base station via an antenna.

A demodulation unit 1120 may provide a function of performing demodulation of a received signal. When the base station transmits an OFDM signal, the demodulation unit 1120 may perform demodulation based on an OFDM scheme. In addition, based on whether the signal generated by the base station corresponds to an FDD scheme or a TDD scheme, the demodulation unit 1120 may perform demodulation according to a corresponding scheme.

The demodulated signal may be descrambled by a descrambling unit 1130 and thus, a codeword having a predetermined length may be generated. A codeword decoding unit 1140 may decode the codeword to be predetermined control information again. The functions may be performed by a signal decoding unit 1190 at once, or may be performed by two or more modules independently or sequentially.

Finally, the resource allocation information expressed by Equations 3, 4, 5, and 7 may be interpreted from decoded control information in an upper layer than a physical layer that decodes the signal.

The control information processing method and apparatus that has been described with reference to FIGS. 10 and 11 may correspond to an example that embodies the resource allocation receiving apparatus and method that has been described with reference to FIGS. 1, 2, 6, and 7. The resource allocation receiving apparatus and method that has been described with reference to FIGS. 1, 2, 6, and 7 may not be limited to the control information processing method and apparatus that has been described with reference to FIGS. 10 and 11, and may be embodied by various methods and apparatuses.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A resource allocating apparatus, the apparatus comprising:
a resource allocation information generating unit to replace each cluster including two or more resource block groups with a single substitute resource block group and to generate resource allocation information based on a number of entire resource block groups including the substitute resource block group, a number of clusters, and substitute resource block group information when resource allocation is performed with respect to one or more clusters having an identical cluster length in the entire resource block groups; and
a resource allocation information transmitting unit to transmit the resource allocation information.

2. The apparatus as claimed in claim 1, wherein the substitute resource block group information corresponds to start resource block group information of each cluster or corresponds to the substitute resource block group information in the entire resource block groups including the substitute resource block group.

3. The apparatus as claimed in claim 1, wherein the number of the entire resource block groups including the substitute resource block group corresponds to a value obtained by subtracting, from the number of the entire resource block groups, a value obtained by multiplying a value obtained by subtracting 1 from a number of resource block groups included in each cluster and the number of clusters.

4. The apparatus as claimed in claim 1, wherein the resource allocation information generating unit generates the resource allocation information based on a coded value obtained by coding the number of the entire resource block groups including the substitute resource block group, the number of clusters, and the substitute resource block group information.

5. The apparatus as claimed in claim 4, wherein the coding corresponds to an Enumerative Source Coding.

6. The apparatus as claimed in claim 4, wherein, when the number of clusters corresponds to a predetermined value, the resource allocation information generating unit generates the resource allocation information by adding, to the coded value, first offset information (1stOffset) that enables a resource allocation receiving apparatus to recognize the cluster length, based on the following equation:
$$\begin{matrix}RIV ( n , x , {s}_{0} , … , {s}_{k - 1} ) = 1 stOffset + Code \\ = {\sum }_{i = 1}^{x - 1} 〈 \begin{matrix}n - ki + k \\ k\end{matrix} 〉 + {\sum }_{j = 0}^{k - 1} 〈 \begin{matrix}n - kx + k - {s}_{j} \\ k - j\end{matrix} 〉\end{matrix}$$
$$〈 \begin{matrix}x \\ y\end{matrix} 〉 = \{ \begin{matrix}( \begin{matrix}x \\ y\end{matrix} ) = {}_{x}^{}{C}{}_{y}^{} & x \geq y \\ 0 & x < y\end{matrix}$$
n: a number of entire resource block groups
k: a number of clusters
x: a cluster length
sⱼ: substitute resource block group information of a j^{th} cluster (j=0, 1, . . . , k−1).

7. The apparatus as claimed in claim 6, wherein the first offset information corresponds to a number of all events that generate a cluster of which a length is shorter than the cluster length from the entire resource block groups.

8. The apparatus as claimed in claim 6, wherein, when the number of clusters is a value in a predetermined range, the resource allocation information generating unit generates the resource allocation information by adding, to a value obtained by adding the first offset information (1stOffset) and the coded value, second offset information (2ndOffset) that enables the resource allocation receiving apparatus to recognize the number of clusters.
$$\begin{matrix}{RIV}^{multi} ( n , x , k ) = 2 ndOffset + RIV ( n , x , {s}_{0} , … , {s}_{k - 1} ) \\ = {\sum }_{l = {k}_{s}}^{k - 1} {RIV}^{max} ( n , {x}_{l}^{max} , l ) + \\ RIV ( n , x , {s}_{0} , … , {s}_{k - 1} )\end{matrix}$$
$${RIV}^{max} ( n , x , k ) = {\sum }_{i = 1}^{x} 〈 \begin{matrix}n - ki + k \\ k\end{matrix} 〉$$
$${x}_{k}^{max} = ⌊ \frac{n - k + 1}{k} ⌋$$

9. The apparatus as claimed in claim 8, wherein the second offset information corresponds to a number of all events that generate a smaller number of clusters than the number of clusters from the entire resource block groups.

10. The apparatus as claimed in claim 1, wherein the cluster length corresponds to a number of resource block groups included in each cluster, and is limited to a value calculated from 2^{α}3^{β}5^{γ}(a≧0, β≧0, γ≧0) when the resource allocation information is resource allocation information for an uplink.

11. The apparatus as claimed in claim 1, wherein the resource block group includes one or more resource blocks.

12. A method of allocating resources, the method comprising:
replacing each cluster including two or more resource block groups with a single substitute resource block group and generating resource allocation information based on a number of entire resource block groups including the substitute resource block group, a number of clusters, and substitute block group information when resource allocation is performed with respect to one or more clusters having an identical cluster length in the entire resource block groups; and
transmitting the resource allocation information.

13. A resource allocation receiving apparatus, the apparatus comprising:
a resource allocation information receiving unit to receive, from a resource allocating apparatus, resource allocation information generated based on a number of entire resource block groups including a substitute resource block group, a number of clusters, and substitute resource block group information when resource allocation is performed in the entire resource block groups and each cluster including two or more resource block groups and having an identical cluster length is replaced with a single substitute resource block group; and
a resource allocation information restoring unit to recognize the cluster length and the substitute resource block group information from the received resource allocation information, to restore start resource block group information of each cluster based on the cluster length and the substitute resource block group information, and to restore end resource block group information of each cluster based on the restored start resource block group information and the cluster length.

14. The apparatus as claimed in claim 13, wherein the resource allocation information further comprises second offset information (2ndOffset) that enables the number of clusters to be recognized; and
when the number of clusters is included in a predetermined range, the resource allocation information restoring unit compares a number of events of a cluster that is generated from the entire resource block groups based on a number of clusters with the second offset information included in the resource allocation information, and recognizes the number of clusters having a predetermined value in the predetermined range.

15. The apparatus as claimed in claim 14, wherein the resource allocation information further comprises first offset information (1stOffset) that enables the cluster length to be recognized; and
the resource allocation information restoring unit performs obtaining resource allocation information associated with the number of clusters having the predetermined value by subtracting the second offset information from the received resource allocation information, and
comparing a number of events of a cluster that is generated from the entire resource block groups for each cluster length with the first offset information included in the resource allocation information obtained in association with the number of clusters having the predetermined value so as to recognize the cluster length.

16. The apparatus as claimed in claim 15, wherein the resource allocation information restoring unit obtains a coded value by subtracting the first offset information from the resource allocation information obtained in association with the number of clusters having the predetermined value, and decodes the coded value so as to recognize the substitute resource block group information; and
the substitute resource block group information corresponds to start resource block group information of each cluster or the substitute resource block group information in the entire resource block groups including the substitute resource block group.

17. The apparatus as claimed in claim 16, wherein the coded value is a value coded based on an Enumerative Source Coding.

18. The apparatus as claimed in claim 13, wherein the resource block group comprises one or more resource blocks.

19. A resource allocation receiving method, the method comprising:
receiving, from a resource allocating apparatus, resource allocation information generated based on a number of entire resource block groups including a substitute resource block group, a number of clusters, and substitute resource block group information when resource allocation is performed in the entire resource block groups and each cluster including two or more resource block groups and having an identical cluster length is replaced with a single substitute resource block group; and
recognizing the cluster length and the substitute resource block group information from the received resource allocation information, restoring start resource block group information of each cluster based on the cluster length and the substitute resource block group information, and restoring end resource block group information of each cluster based on the restored start resource block group information and the cluster length.

20. A method for a base station to transmit control information, the method comprising:
adding a Cyclic Redundancy Check (CRC) for error detection to control information including resource allocation information that is expressed as RIV(n, x, S₀, . . . , Sₖ₋₁) or RIV^{multi}(n,x,k) as given below;
generating coded data by performing channel coding on the CRC-added control information;
generating modulated symbols by modulating the coded data; and
mapping the modulated symbols on a physical resource element and transmitting the mapped modulated symbols to a user equipment.
$$\begin{matrix}RIV ( n , x , {s}_{0} , … , {s}_{k - 1} ) = 1 stOffset + Code \\ = {\sum }_{i = 1}^{x - 1} 〈 \begin{matrix}n - ki + k \\ k\end{matrix} 〉 + {\sum }_{j = 0}^{k - 1} 〈 \begin{matrix}n - kx + k - {s}_{j} \\ k - j\end{matrix} 〉\end{matrix}$$
$$〈 \begin{matrix}x \\ y\end{matrix} 〉 = \{ \begin{matrix}( \begin{matrix}x \\ y\end{matrix} ) = {}_{x}^{}{C}{}_{y}^{} & x \geq y \\ 0 & x < y\end{matrix}$$
n: a number of entire resource block groups
k: a number of clusters
x: a cluster length
sⱼ: substitute resource block group information of a j^{th} cluster (j=0, 1, . . . , k−1)
$$\begin{matrix}{RIV}^{multi} ( n , x , k ) = 2 ndOffset + RIV ( n , x , {s}_{0} , … , {s}_{k - 1} ) \\ = {\sum }_{l = {k}_{s}}^{k - 1} {RIV}^{max} ( n , {x}_{l}^{max} , l ) + \\ RIV ( n , x , {s}_{0} , … , {s}_{k - 1} )\end{matrix}$$
$${RIV}^{max} ( n , x , k ) = {\sum }_{i = 1}^{x} 〈 \begin{matrix}n - ki + k \\ k\end{matrix} 〉$$
$${x}_{k}^{max} = ⌊ \frac{n - k + 1}{k} ⌋$$

21. A method for a user equipment to process control information, the method comprising:
demapping symbols from a received physical resource element;
generating data by demodulating the demapped symbols;
performing channel decoding on the demodulated data and performing CRC so as to detect whether an error occurs;
obtaining required control information by removing a CRC from the decoded data; and
interpreting, based on the obtained control information, resource allocation information expressed as RIV(n, x, S₀, . . . , Sₖ₋₁) or RIV^{multi}(n,x,k) as given below:
$$\begin{matrix}RIV ( n , x , {s}_{0} , … , {s}_{k - 1} ) = 1 stOffset + Code \\ = {\sum }_{i = 1}^{x - 1} 〈 \begin{matrix}n - ki + k \\ k\end{matrix} 〉 + {\sum }_{j = 0}^{k - 1} 〈 \begin{matrix}n - kx + k - {s}_{j} \\ k - j\end{matrix} 〉\end{matrix}$$
$$〈 \begin{matrix}x \\ y\end{matrix} 〉 = \{ \begin{matrix}( \begin{matrix}x \\ y\end{matrix} ) = {}_{x}^{}{C}{}_{y}^{} & x \geq y \\ 0 & x < y\end{matrix}$$
n: a number of entire resource block groups
k: a number of clusters
x: a cluster length
sⱼ: substitute resource block group information of a j^{th} cluster (j=0, 1, . . . , k−1)
$$\begin{matrix}{RIV}^{multi} ( n , x , k ) = 2 ndOffset + RIV ( n , x , {s}_{0} , … , {s}_{k - 1} ) \\ = {\sum }_{l = {k}_{s}}^{k - 1} {RIV}^{max} ( n , {x}_{l}^{max} , l ) + \\ RIV ( n , x , {s}_{0} , … , {s}_{k - 1} )\end{matrix}$$
$${RIV}^{max} ( n , x , k ) = {\sum }_{i = 1}^{x} 〈 \begin{matrix}n - ki + k \\ k\end{matrix} 〉$$
$${x}_{k}^{max} = ⌊ \frac{n - k + 1}{k} ⌋$$
